(19) United States
(12) Patent Application Publication
(10) Pub. No.: US 2025/0391060 A1
(43) Pub. Date: Dec. 25, 2025

(54) IMAGE ACQUISITION DEVICE, IMAGE ACQUISITION METHOD, AND STORAGE MEDIUM

(71) Applicants: NEC Corporation, Tokyo (JP); Tokyo University of Science Foundation, Tokyo (JP)

(72) Inventors: Takashi Shibata, Tokyo (JP); Go Irie, Tokyo (JP)

(73) Assignees: NEC Corporation, Tokyo (JP); Tokyo University of Science Foundation, Tokyo (JP)

(21) Appl. No.: 19/237,350

(22) Filed: Jun. 13, 2025

(30) Foreign Application Priority Data
Jun. 21, 2024 (JP) 2024-100807

(51) Int. Cl. G06T 11/00; G06F 16/53; G06F 16/56; G06V 10/40; G06V 10/764

(52) U.S. Cl. CPC G06T 11/00; G06F 16/53; G06F 16/56; G06V 10/40; G06V 10/764

(57) ABSTRACT

An image acquisition device performs prompt learning using an evaluation function that indicates a worse evaluation the higher the similarity between an image feature vector, which is the feature vector of the input image, and the prompt feature vector, which is the feature vector of a combined prompt formed by combining a base prompt indicating a class in image classification and the input image class and a control prompt, which is data to be updated in a case where the class of an input image used to learn a prompt is a suppression target class, which is a class in which image output should be suppressed, and indicates a better evaluation the higher the similarity between the image feature vector and the prompt feature vector in a case where the input image class is a class other than the suppression target class, and acquires an image using the learned prompt.

### CROSS-REFERENCE TO RELATED APPLICATIONS

This application is based upon and claims the benefit of priority from Japanese patent application No. 2024-100807, filed on Jun. 21, 2024, the disclosure of which is incorporated herein in its entirety by reference.

### TECHNICAL FIELD

The present disclosure relates to an image acquisition device, an image acquisition method, and a storage medium.

### BACKGROUND ART

There are cases where an image is output in response to a prompt input, such as in a case where an image is generated in response to an input of text data or the like.

For example, the information processing system described in Japanese Patent No. 7404596 inputs a prompt to a language model to output information related to desired information input by a user, and generates text data related to the desired information. In addition, the information processing system generates an image related to a topic by inputting a prompt to output an image corresponding to the image generation model based on the desired information or text data related to the desired information.

In a case where an image is output in response to input of a prompt, it is preferable to be able to reduce the possibility of an image that is deemed undesirable being output.

### SUMMARY

An example of an objective of the present disclosure is to provide an image acquisition device, a prompt learning device, an image acquisition method, a prompt learning method, and a program that can solve the above-mentioned problems.

According to a first example aspect of the present disclosure, an image acquisition device is provided with: an image feature extraction means for extracting an image feature vector, which is a feature vector of an input image that is an image of any one of the classes in image classification; a prompt feature extraction means for extracting a prompt feature vector, which is a feature vector of a combined prompt, which is data formed by combining a base prompt, which is data indicating a class in the image classification and an input image class, which is a class of the input image, and a control prompt, which is data to be updated; a similarity calculation means for calculating the similarity between the prompt feature vector and the image feature vector; a control prompt update means for updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better; and an output image acquisition means for acquiring an image using the prompt feature vector according to the updated control prompt.

According to a second example aspect of the present disclosure, a prompt learning device is provided with: an image feature extraction means for extracting an image feature vector, which is a feature vector of an input image that is an image of any one of the classes in image classification; a prompt feature extraction means for extracting a prompt feature vector, which is a feature vector of a combined prompt, which is data formed by combining a base prompt, which is data indicating a class in the image classification and an input image class, which is a class of the input image, and a control prompt, which is data to be updated; a similarity calculation means for calculating the similarity between the prompt feature vector and the image feature vector; and a control prompt update means for updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

According to a third example aspect of the present disclosure, an image acquisition method includes a computer performing the steps of: extracting an image feature vector, which is a feature vector of an input image that is an image of any one of classes in image classification; extracting a prompt feature vector, which is a feature vector of a combined prompt, which is data formed by combining a base prompt, which is data indicating a class in the image classification and an input image class, which is a class of the input image, and a control prompt, which is data to be updated, and calculating a similarity between the prompt feature vector and the image feature vector; updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better; and acquiring an image using the prompt feature vector according to the updated control prompt.

According to a fourth example aspect of the present disclosure, a prompt learning method includes a computer performing the steps of: extracting an image feature vector, which is a feature vector of an input image that is an image of any one of classes in image classification; extracting a prompt feature vector, which is a feature vector of a combined prompt, which is data formed by combining a base prompt, which is data indicating a class in the image classification and an input image class, which is a class of the input image, and a control prompt, which is data to be updated, and calculating a similarity between the prompt feature vector and the image feature vector; and updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

According to a fifth example aspect of the present disclosure, a program causes a computer to execute the steps of: extracting an image feature vector, which is a feature vector of an input image that is an image of any one of classes in image classification; extracting a prompt feature vector, which is a feature vector of a combined prompt, which is data formed by combining a base prompt, which is data indicating a class in the image classification and an input image class, which is a class of the input image, and a control prompt, which is data to be updated; calculating a similarity between the prompt feature vector and the image feature vector, and updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better; and acquiring an image using the prompt feature vector according to the updated control prompt.

According to a sixth example aspect of the present disclosure, a program causes a computer to execute the steps of: extracting an image feature vector, which is a feature vector of an input image that is an image of any one of classes in image classification; extracting a prompt feature vector, which is a feature vector of a combined prompt, which is data formed by combining a base prompt, which is data indicating a class in the image classification and an input image class, which is a class of the input image, and a control prompt, which is data to be updated; and calculating a similarity between the prompt feature vector and the image feature vector, and updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

### BRIEF DESCRIPTION OF THE DRAWINGS

FIG. 1 illustrates an example configuration of an image acquisition device according to at least one example embodiment.

FIG. 2 is a diagram illustrating an example of data input/output at each part of a processing portion according to at least one example embodiment.

FIG. 3 is a diagram illustrating a first example of a configuration of an output image acquisition portion and data input/output according to at least one example embodiment.

FIG. 4 is a diagram illustrating a second example of a configuration of an output image acquisition portion and data input/output according to at least one example embodiment.

FIG. 5 is a diagram illustrating a third example of a configuration of an output image acquisition portion and data input/output according to at least one example embodiment.

FIG. 6 is a diagram illustrating an example of a processing procedure performed by an image acquisition device according to at least one example embodiment.

FIG. 7 illustrates an example configuration of an image acquisition system according to at least one example embodiment.

FIG. 8 illustrates an example configuration of a prompt learning device according to at least one example embodiment.

FIG. 9 illustrates an example configuration of an image acquisition device according to at least one example embodiment.

FIG. 10 illustrates an example configuration of a prompt learning device according to at least one example embodiment.

FIG. 11 is a diagram illustrating an example of the processing steps in the image acquisition method of at least one example embodiment.

FIG. 12 illustrates an example of the processing steps in the prompt learning method of at least one example embodiment.

FIG. 13 illustrates an example configuration of a computer in accordance with at least one example embodiment.

### EXAMPLE EMBODIMENT

Hereinbelow, example embodiments of the present disclosure will be described, but the disclosure according to the claims is not limited to the following example embodiments. Furthermore, not all of the combinations of features described in the example embodiments are necessarily essential to the solutions of the disclosure.

### First Example Embodiment

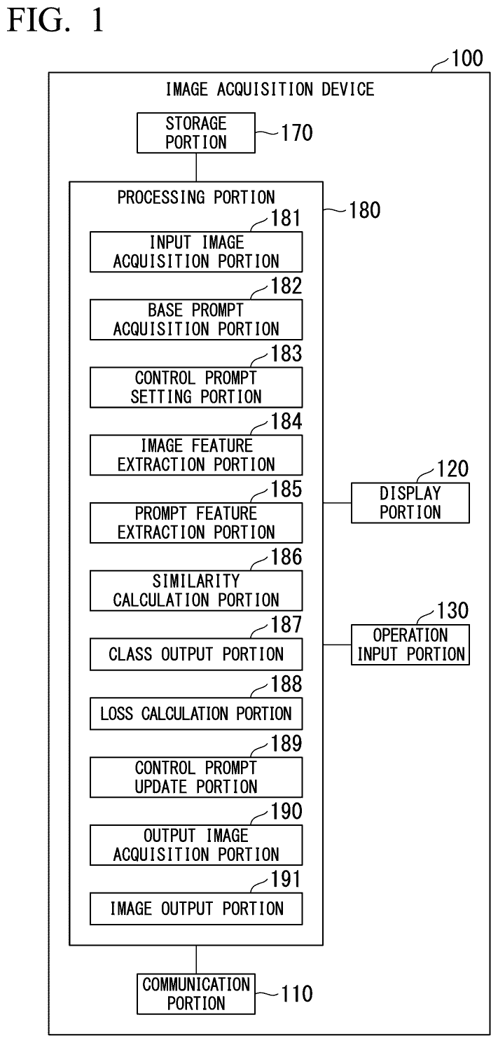

FIG. 1 illustrates an example configuration of an image acquisition device according to at least one example embodiment. In the configuration shown in FIG. 1, an image acquisition device 100 is provided with a communication portion 110, a display portion 120, an operation input portion 130, a storage portion 170, and a processing portion 180.

The processing portion 180 is provided with an input image acquisition portion 181, a base prompt acquisition portion 182, a control prompt setting portion 183, an image feature extraction portion 184, a prompt feature extraction portion 185, a similarity calculation portion 186, a class output portion 187, a loss calculation portion 188, a control prompt update portion 189, an output image acquisition portion 190, and an image output portion 191.

The image acquisition device 100 receives a prompt and outputs an image. In particular, the image acquisition device 100 reduces the likelihood of outputting images that are deemed undesirable.

The image acquisition device 100 may be configured using a computer such as a personal computer (PC) or a workstation (WS).

The image acquisition device 100 provides an updateable portion of the prompt and updates the prompt with sample data to reduce the likelihood of outputting an undesirable image. The prompt here refers to input data for requesting an action from the device. A character string (text data) may be used as the prompt, but is not limited to this. For example, the prompt, or a portion thereof, may be numerical data.

The portion of the prompt that can be updated is also called the control prompt. The portion of the prompt other than the control prompt is also called a base prompt. A prompt that combines a control prompt and a base prompt (the entire prompt) is also called a combined prompt.

The combining of prompts here may be the combining of prompts as character strings or bit strings. The combining of two pieces of data here means joining the end of one piece of data to the beginning of the other piece of data to combine them into one piece of data. However, the manner in which the image acquisition device 100 combines the base prompt and the control prompt is not limited to any particular manner. The method by which the image acquisition device 100 combines the base prompt and the control prompt can be any method that allow the combined prompt to be broken down into parts (tokens).

Updating a prompt may be referred to as prompt learning or prompt training. The sample data used for prompt learning is also referred to as training data. The image acquisition device 100 may perform prompt learning using known machine learning techniques, such as backpropagation.

The image acquisition device 100 uses image classification techniques to perform prompt learning to reduce the likelihood of outputting images of an undesirable class.

Now consider the case where image acquisition device 100 generates and outputs an image based on a prompt. In the case of image generation, there is a wide variety of images that can be generated, and the process of reducing the likelihood of generating a particular image (e.g., an image that satisfies specified conditions) is considered to be complex.

In response to this, the image acquisition device 100 uses an image classification technique to reduce the possibility of outputting an image of an undesirable class. According to the image acquisition device 100, the number of classes to be subjected to classification is relatively small (e.g., smaller than the number of images that may be generated in image generation), and therefore it is expected that the possibility of outputting an undesirable image can be reduced with relatively simple processing (relatively simple learning).

A class in image classification (all classes into which images are classified) is also referred to as an input image class. Among the input image classes, classes that are deemed undesirable are also referred to as suppression target classes. The suppression target class can be considered as a class whose image output should be suppressed.

Another possible method of reducing the likelihood that the image acquisition device 100 will output an image that is deemed undesirable is to relearn the process by which the image acquisition device 100 acquires an image, such as the image generation process. However, learning a process that acquires learning based on a prompt, such as an image generation process, is considered to have a high learning cost (training cost). For example, learning a process for acquiring an image based on a prompt, such as an image generation process, requires a large amount of training data, and the training may take a long time.

In contrast, the learning performed by the image acquisition device 100 can be understood as using a learned machine learning model as is for image acquisition, and fine-tuning the machine learning model that generates input data for the machine learning model for image acquisition so as to reduce the possibility of outputting images that are deemed undesirable.

According to the image acquisition device 100, since a learned machine learning model for acquiring images is used as is, it is expected that the possibility of outputting an undesirable image can be reduced with relatively simple processing (relatively simple learning).

The operator who causes the image acquisition device 100 to learn the prompts may be the same person as the user who requests images from the image acquisition device 100, or may be a different person.

For example, in a case where an administrator of the image acquisition device 100 makes the image acquisition device 100 available to the public, the administrator may have the image acquisition device 100 learn prompts in order to reduce the possibility of the image acquisition device 100 outputting images that are considered socially undesirable.

Alternatively, the method of prompt learning may be disclosed to the users of the image acquisition device 100. Then, in a case where a user requests an image from the image acquisition device 100, the image acquisition device 100 may be configured to perform prompt learning in order to reduce the possibility that an image that is not desirable to the user (an image that the user does not want) is output. In a case where multiple users share a single image acquisition device 100, the image acquisition device 100 may be configured to store learned prompts (prompts obtained through learning) for each user.

The communication portion 110 communicates with other devices. For example, the communication portion 110 may be configured to receive image data used as an input image (image data used as part of the training data) from another device.

The display portion 120 has a display screen, such as a liquid crystal panel or a Light Emitting Diode (LED) panel, and displays various images. For example, the display portion 120 may be configured to display prompts and sample data for prompt learning.

The operation input portion 130 includes input devices such as a keyboard and a mouse, and receives user operations. For example, the operation input portion 130 may be configured to receive an input operation for settings related to the learning of a prompt, such as the learning rate in prompt learning. Furthermore, the operation input portion 130 may be configured to receive an input operation for a base prompt.

The storage portion 170 stores various types of data. For example, the storage portion 170 may be configured to store training data, base prompts, control prompts, combined prompts, evaluation functions for learning prompts, and settings for learning prompts such as learning rates, or a subset of these.

The storage portion 170 is configured using a storage device provided in the image acquisition device 100.

The processing portion 180 controls each component of the image acquisition device 100 to perform various processes. The functions of the processing portion 180 are performed, for example, by a Central Processing Unit (CPU) included in the image acquisition device 100 reading and executing a program from the storage portion 170.

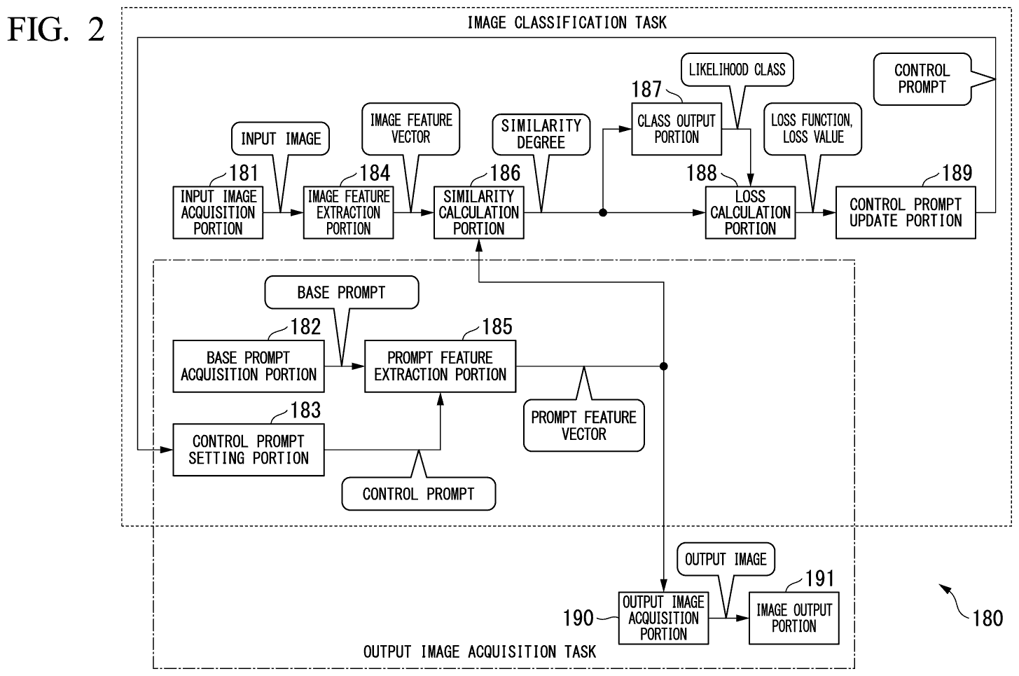

FIG. 2 is a diagram showing an example of data input/output in each component of the processing portion 180.

The input image acquisition portion 181 acquires one or more images including an image of a suppression target class. The images acquired by the input image acquisition portion 181 are also referred to as input images. The combination of an input image and a prompt indicative of the class of the input image is used as training data for the image acquisition device 100 to perform prompt learning. The class of an image here is the class into which the image is classified by classification.

The input image acquisition portion 181 outputs the input image to the image feature extraction portion 184.

The method by which the input image acquisition portion 181 acquires input images is not limited to a specific method. For example, the input image acquisition portion 181 may be configured to acquire training data prepared in another device. Alternatively, the input image acquisition portion 181 may be configured to acquire input images from another device in accordance with a user operation.

Alternatively, the input image acquisition portion 181 may be configured to receive a keyword indicating an input image class, and search for an input image using the specified keyword. For example, it may perform a search for input images via an Internet using the specified keyword. Alternatively, the input image acquisition portion 181 may perform a search for an input image using a foundation model that receives a prompt including a keyword and outputs an image that corresponds to that keyword.

By having the input image acquisition portion 181 search for input images, the operator who causes the image acquisition device 100 to perform prompt learning does not need to manually input images to the image acquisition device 100. In this respect, it is expected that the image acquisition device 100 can reduce the burden on the operator who causes the image acquisition device 100 to learn the prompts.

The designation of a keyword for the input image acquisition portion 181 may be performed by inputting a base prompt including the keyword to the image acquisition device 100.

The base prompt acquisition portion 182 acquires base prompts. In particular, the base prompt acquisition portion 182 acquires, for each input image, a base prompt that indicates the class of the input image (input image class).

The base prompt acquisition portion 182 outputs the base prompt to the prompt feature extraction portion 185. In particular, the base prompt acquisition portion 182 outputs a base prompt indicating the class in the image classification and the input image class to the prompt feature extraction portion 185.

The base prompt is used as a correct label (supervised data) for the class of the input image in a case where the image acquisition device 100 performs prompt learning. Furthermore, in a case where the image acquisition device 100 captures an output image, the base prompt is used as a prompt indicating a request regarding the output image.

The output image here is an image acquired and output by the image acquisition device 100. The image acquisition device 100 may be configured to generate the output image. The image acquisition device 100 may also acquire the output image by image search.

The same base prompt may be used during prompt learning and in a case where acquiring the output image, or different base prompts may be used. In a case where a base prompt different from that used in a case where learning the prompt is used in a case where acquiring the output image, the image acquisition device 100 may use a combined prompt that combines the base prompt for acquiring the output image and the learned control prompt as the prompt for acquiring the output image.

The base prompt may include data indicative of all or a subset of the classes in the image classification in addition to the input image class. For example, the base prompt may include keywords for each class in an image classification and a keyword for the output image class. In this case, the image acquisition device 100 may distinguish between keywords of each class in the image classification and keywords of the output image class depending on the position of the keyword in the base prompt.

However, the method by which the image acquisition device 100 acquires information indicating classes in image classification (information for identifying a class), such as a keyword for the class in image classification, is not limited to a specific method. For example, the storage portion 170 may store in advance keywords for each class in image classification. The base prompt acquisition portion 182 may also aggregate the input image classes indicated in the base prompts for all base prompts, and generate a set of input image classes. Here, “aggregation” means that the classes are counted so that the same class is not duplicated. The image acquisition device 100 may then use the set of input image classes as the complete set of classes in image classification.

If the base prompt acquired by the base prompt acquisition portion 182 does not include data indicating all classes in the image classification, data indicating all classes in the image classification may be inserted into the base prompt and output to the prompt feature extraction portion 185. The act of the base prompt acquisition portion 182 inserting data indicating classes in image classification into a base prompt indicating the input image class can be considered as acquiring a base prompt indicating both the class in image classification and the input image class.

The base prompt may include data indicating the class to be suppressed in addition to the input image class. For example, each base prompt may include a flag indicating whether the input image class indicated by the base prompt corresponds to the class to be suppressed.

However, the method by which the image acquisition device 100 acquires information indicating the suppression target class is not limited to a specific method. For example, the storage portion 170 may store keywords of the suppression target class in advance.

If the base prompt acquired by the base prompt acquisition portion 182 contains data indicating a suppression target class, the data indicating the suppression target class may be deleted from the base prompt and output to the prompt feature extraction portion 185.

The control prompt setting portion 183 sets the control prompt. That is, the control prompt setting portion 183 sets the value of the control prompt. The control prompt setting portion 183 may set a random value as the initial value of the control prompt. For example, the control prompt setting portion 183 sets a random value as the initial value of the control prompt. A random string of text may be set. Furthermore, in a case where the control prompt update portion 189 updates the control prompt during prompt learning, the control prompt setting portion 183 may use the updated control prompt as is.

The control prompt setting portion 183 outputs the control prompt to the prompt feature extraction portion 185.

The image feature extraction portion 184 extracts a feature vector of each input image. The feature vector of each input image is also referred to as an image feature vector.

The image feature extraction portion 184 corresponds to an example of an image feature extraction means.

The image feature extraction portion 184 outputs the image feature vector to the similarity calculation portion 186.

The prompt feature extraction portion 185 generates a combined prompt by combining the base prompt and the control prompt, and breaks down the resulting combined prompt into elements (tokens). Then, the prompt feature extraction portion 185 extracts a feature vector for each of the obtained elements. The feature vector for each element generated by the prompt feature extraction portion 185 is also referred to as a prompt feature vector. The prompt feature vector can be thought of as the feature vector of the combined prompt. The prompt feature extraction portion 185 corresponds to an example of a prompt feature extraction means.

The prompt feature extraction portion 185 outputs the prompt feature vector to the similarity calculation portion 186.

Furthermore, if the same base prompt is used during prompt learning and in a case where acquiring the output image, the prompt feature extraction portion 185 outputs the prompt feature vector of the learned combined prompt to the output image acquisition portion 190. The “learned combined prompt” referred to here is a prompt formed by combining the base prompt acquired by the base prompt acquisition portion 182 during prompt learning with the learned control prompt.

On the other hand, in a case where different base prompts are used during prompt learning and in a case where acquiring the output image, the prompt feature extraction portion 185 outputs to the output image acquisition portion 190 the prompt feature vector of a combined prompt that combines the base prompt for acquiring the output image and the learned control prompt.

The prompt feature extraction portion 185 outputting the prompt feature vector to the similarity calculation portion 186 and the output image acquisition portion 190 can be considered as using the same text encoder for both the classification of images during prompt learning and the acquisition of the output image in a case where acquiring the output image (e.g., generation of the output image).

The similarity calculation portion 186 calculates the similarity between the image feature vector extracted by the image feature extraction portion 184 and the prompt feature vector extracted by the prompt feature extraction portion 185 for each combination of an input image and a base prompt in the training data. In particular, the similarity calculation portion 186 calculates, for each element of the combined prompt, the similarity between the feature vector of that element and the image feature vector. The similarity for each element of the combined prompt calculated by the similarity calculation portion 186 can, for each class, be used as data indicating the likelihood that the input data will be classified into that class.

The similarity calculation portion 186 corresponds to an example of a similarity calculation means.

The similarity calculation portion 186 outputs the calculated similarity to the class output portion 187 and the loss calculation portion 188.

In the following, an example will be described in which the similarity calculation portion 186 uses cosine similarity as the similarity. However, the similarity used by the similarity calculation portion 186 is not limited to a specific one, and various similarities that can calculate the similarity between two vectors can be used.

The similarity calculation portion 186 may use a similarity metric in which a larger similarity index value indicates a higher degree of similarity between two vectors. For example, in a case where the similarity calculation portion 186 uses cosine similarity, a larger value of the cosine similarity indicates a higher similarity between the two vectors.

Alternatively, the similarity calculation portion 186 may use a similarity metric in which a smaller similarity index value indicates a higher similarity between two vectors. For example, the similarity calculation portion 186 may use the Euclidean distance in a vector space as the similarity. In this case, a smaller Euclidean distance value indicates a higher degree of similarity between the two vectors.

The class output portion 187 detects the class having the highest similarity calculated by the similarity calculation portion 186. The class detected by the class output portion 187 can be considered as the class for which the likelihood of the image being classified into that class is the highest (greatest). The class with the highest likelihood of the input image being classified into it is also referred to as the most likely

The class output portion 187 outputs information indicating the detected class to the loss calculation portion 188. Outputting information indicating a class is also referred to as outputting that class.

The loss calculation portion 188 calculates the value of a loss function used in learning the prompt.

The loss calculation portion 188 outputs the calculated loss value (value of the loss function) to the control prompt update portion 189.

However, the evaluation function used by the image acquisition device 100 to learn the prompt is not limited to a loss function. The image acquisition device 100 may use an evaluation function value in which a larger evaluation value indicates a better evaluation. In a case where the image acquisition device 100 uses a loss function as the evaluation function, it can be understood that a smaller loss value indicates a better evaluation.

In addition, the image acquisition device 100 uses an evaluation function that, for classes to be suppressed, the more similar the input image vector and the prompt feature vector are, the worse the evaluation is, and, for classes other than the classes to be suppressed, the more similar the input image vector and the prompt feature vector are, the better the evaluation is.

Specifically, the evaluation function used by the image acquisition device 100 is such that, in a case where the input image class is a class to be suppressed, the greater the similarity (the higher the similarity) between the image feature vector and the prompt feature vector, the worse the evaluation value that is output. For example, in a case where the image acquisition device 100 uses a loss function, if the input image class is a suppression target class, the greater the similarity between the image feature vector and the prompt feature vector, the greater the loss value.

In addition, in a case where the input image class is a class other than the class to be suppressed, the evaluation function used by the image acquisition device 100 outputs an evaluation value that indicates a better evaluation in a case where the similarity between the image feature vector and the prompt feature vector is greater (the higher the similarity). For example, in a case where the image acquisition device 100 uses a loss function, if the input image class is a class other than the suppression target class, the greater the similarity between the image feature vector and the prompt feature vector, the smaller the loss value.

In calculating the evaluation function value, the loss calculation portion 188 uses the feature vector of the element corresponding to the input image class, among the feature vectors extracted by the similarity calculation portion 186 for each element of the combined prompt. Therefore, in calculating the evaluation function value, the loss calculation portion 188 uses the likelihood that the input image will be classified into the input image class as the similarity between the image feature vector and the prompt feature vector.

The loss calculation portion 188 may use the input image class indicated in the base prompt as the input image class. Alternatively, the loss calculation portion 188 may use the most likely class detected by the class output portion 187 as the input image class.

The control prompt update portion 189 updates the control prompt so that the loss value calculated by the loss calculation portion 188 becomes smaller. The update of the control prompts performed by the control prompt update portion 189 can be considered as performing prompt learning so that the classification accuracy of images in the suppression target class decreases and the classification accuracy of images in classes other than the suppression class increases.

The control prompt update portion 189 corresponds to an example of a control prompt update means.

The control prompt update portion 189 outputs the updated control prompt to the control prompt setting portion 183.

As described above with respect to the image acquisition device 100, the control prompt update portion 189 may update the control prompt using a machine learning technique that employs the derivative of a loss function, such as backpropagation. Here, the combination of the prompt feature extraction portion 185, the similarity calculation portion 186, and the loss calculation portion 188 can be considered to correspond to a loss function that takes the control prompt as an argument. The loss function resulting from the combination of the functions of these units may be expressed by a mathematical formula, and the prompt feature extraction portion 185 may update the control prompt using the derivative of the loss function expressed by that mathematical formula.

In a case where the control prompt update portion 189 converts the feature vector of the control prompt (the feature vector for each element of the control prompt) into a character string (text), the storage portion 170 may store a data table in which, for each character string that can be used as an element value of the control prompt, the feature vector (the value of the feature vector) into which the prompt feature extraction portion 185 converts the character string is associated. The control prompt update portion 189 may then refer to the data table to convert the feature vector of the control prompt into a character string.

The output image acquisition portion 190 acquires an output image using a prompt feature vector based on the learned control prompt. The output image acquisition portion 190 may generate the output image. Alternatively, the output image acquisition portion 190 may acquire the output image by performing an image search.

The output image acquisition portion 190 corresponds to an example of an output image acquisition means.

The output image acquisition portion 190 outputs the output image to the image output portion 191.

The image output portion 191 outputs an output image.

The method by which the image output portion 191 outputs the output image is not limited to a specific method. For example, the image output portion 191 may control the display portion 120 to display the output image. Alternatively, the image output portion 191 may control the communication portion 110 to transmit the output image to another device.

In the example of FIG. 2, the processing performed by the combination of the input image acquisition portion 181, the base prompt acquisition portion 182, the control prompt setting portion 183, the image feature extraction portion 184, the prompt feature extraction portion 185, the similarity calculation portion 186, the class output portion 187, the loss calculation portion 188, and the control prompt update portion 189 can be considered as learning a prompt using an image classification task.

Furthermore, the process performed by the combination of the base prompt acquisition portion 182, the control prompt setting portion 183, the prompt feature extraction portion 185, the output image acquisition portion 190, and the image output portion 191 can be considered as an output image acquisition task.

The image acquisition device 100 can be thought of as sharing the control prompts and the text encoder function provided by the prompt feature extractor 185 between the image classification task and the output image acquisition task.

As a result, in the image acquisition device 100, it is considered that the accuracy of classifying images in the suppression target class decreases in a case where the output image acquisition task is performed, just as in a case where prompt learning is performed using the image classification task. This is expected to reduce the possibility that the output image acquisition portion 190 will acquire an image that is classified into a suppression target class.

In a case where the output image acquisition portion 190 generates an output image, it is considered that the possibility of recognizing a request for an output image indicated in the base prompt as a request for an image classified into the suppression target class is reduced. This is expected to reduce the possibility that the output image acquisition portion 190 will generate an image that is classified into the suppression target class.

In a case where the output image acquisition portion 190 acquires an output image through an image search, it is considered that the possibility of recognizing an image that is a candidate in the image search as an image classified as belonging to the suppression target class is reduced. This is expected to reduce the possibility that the output image acquisition portion 190 will recognize and acquire an image that is a candidate in the image search as an image classified as belonging to the suppression target class, even if the request for an output image shown in the base prompt is for an image classified as belonging to the suppression target class.

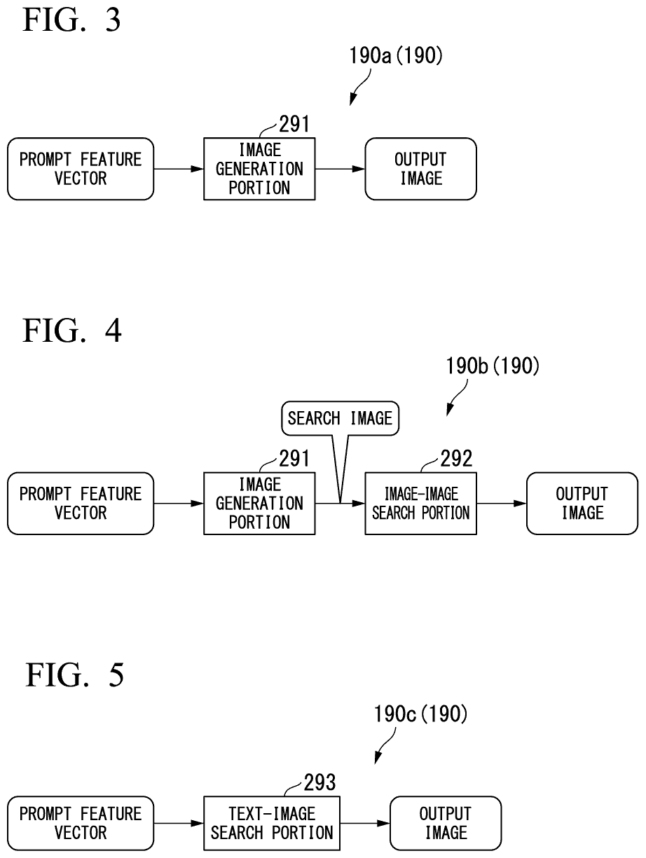

FIG. 3 is a diagram showing a first example of the configuration of the output image acquisition portion 190 and data input/output. In the example of FIG. 3, the output image acquisition portion 190 includes an image generation portion 291. The output image acquisition portion 190 in the example of FIG. 3 is also referred to as an output image acquisition portion 190a.

The image generation portion 291 receives a prompt feature vector based on the learned control prompt and generates an output image. The image generating portion 291 outputs the generated output image to the image output portion 191.

As described above with respect to the case where the output image acquisition portion 190 generates an output image, it is expected that the possibility that the image generation portion 291 generates an image classified into a suppression target class is reduced.

The function of the image generating portion 291 may be that of an existing foundation model that receives a prompt input and generates an image. Each component for learning prompts may be built into an existing foundation model system that receives prompt input and generates images.

FIG. 4 is a diagram showing a second example of the configuration of the output image acquisition portion 190 and data input/output. In the example of FIG. 4, the output image acquisition portion 190 includes an image generation portion 291 and an image-image search portion 292. The output image acquisition portion 190 in the example of FIG. 4 is also referred to as an output image acquisition portion 190b.

The function of the image generating portion 291 in the example of FIG. 4 is similar to the function of the image generation portion 291 in the example of FIG. 3. In the example of FIG. 4, the image generating portion 291 outputs the generated image to the image-image search portion 292.

The image-image search portion 292 performs an image-image search using the image generated by the image generation portion 291 as the search image. The image-image search referred to here is a search for images similar to the search image.

As described above with respect to the case where the output image acquisition portion 190 generates an output image, it is expected that the possibility that the image generation portion 291 generates an image classified into a suppression target class is reduced. This reduces the likelihood that the image-image search portion 292 will perform an image-image search using an image classified as belonging to the suppression target class as a search image, and is therefore expected to reduce the likelihood that the image-image search portion 292 will acquire an image classified as belonging to the suppression target class as a search result.

As in the case of the example of FIG. 3, in the case of the example of FIG. 4, the function of the image generating portion 291 may be the function of an existing foundation model that generates an image in response to a prompt input. Each component for learning prompts may be built into an existing foundation model system that receives prompt input and generates images.

Furthermore, as the function of the image-image search portion 292, the function of an existing search engine that performs an image-image search may be used. The image-image search portion 292 may be configured using an existing search engine that performs image-image searches.

FIG. 5 is a diagram showing a third example of the configuration of the output image acquisition portion 190 and data input/output. In the example of FIG. 5, the output image acquisition portion 190 includes a text-image search portion 293. The output image acquisition portion 190 in the example of FIG. 5 is also referred to as an output image acquisition portion 190c.

The text-image search portion 293 performs an image search using a prompt feature vector. The image search performed by the text-image search portion 293 can be considered as a text-image search using a combined prompt. The text-image search referred to here is a search for an image having characteristics expressed by a character string (text data).

As described above regarding the case where the output image acquisition portion 190 acquires an output image through an image search, it is expected that the possibility that the text-image search portion 293 acquires an image classified into a suppression target class through the image search will be reduced.

The function of the text-image search portion 293 may be an existing foundation model function that searches for images in response to a prompt input. Each component for prompt learning may be integrated into an existing foundation model system that receives a prompt and searches for an image.

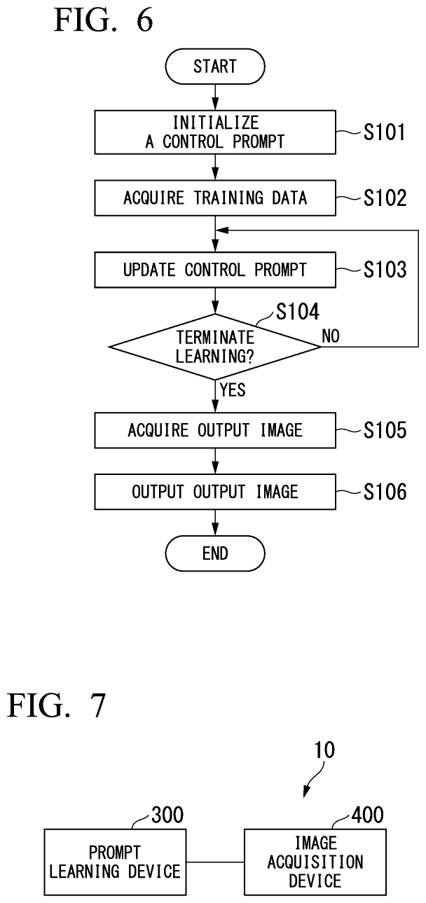

FIG. 6 is a diagram showing an example of the processing procedure performed by the image acquisition device 100.

In the process of FIG. 6, the control prompt setting portion 183 initializes a control prompt (Step S101). For example, the control prompt setting portion 183 sets the initial value of the control prompt to a random value.

Next, the image acquisition device 100 acquires training data for learning the prompt (Step S102). Specifically, the input image acquisition portion 181 acquires an input image, and the base prompt acquisition portion 182 acquires a base prompt.

Next, the control prompt update portion 189 updates the control prompt (Step S103). As described above, the control prompt update portion 189 updates the control prompt so that, for a suppression target class, the more similar the input image vector and the prompt feature vector are, the greater the loss, and, for classes other than the suppression target class, the more similar the input image vector and the prompt feature vector are, the smaller the value (loss) of the loss function becomes.

Next, the processing portion 180 determines whether or not to terminate the prompt learning (Step S104). Specifically, the processing portion 180 determines whether a condition for terminating the prompt learning has been met. The termination condition here is not limited to a specific condition. For example, the termination condition here may be that the control prompt update portion 189 has repeated updating of the control prompt in Step S103 a predetermined number of times or more. Alternatively, the termination condition here may be that the likelihood that an image of the suppression target class will be classified into the suppression target class is less than or equal to a predetermined value, and that the likelihood that an image of a class other than the suppression target class will be classified into the correct class is greater than or equal to a predetermined value.

If the processing portion 180 determines that the learning of the prompt should not be terminated (Step S104: NO), the process returns to Step S103.

On the other hand, if the processing portion 180 determines that the learning of the prompt is to be terminated (Step S104: YES), the output image acquisition portion 190 acquires an output image (Step S105). As described above, the output image acquisition portion 190 acquires the output image using the prompt feature vector of the combined prompt that uses the learned control prompt.

Next, the image output portion 191 outputs the output image (Step S106). As described above, the method by which the image output portion 191 outputs the output image is not limited to a specific method.

After Step S106, the image acquisition device 100 ends the processing of FIG. 6.

As described above, the image feature extraction portion 184 extracts an image feature vector, which is a feature vector of an input image that is an image of any one of the classes in image classification.

The prompt feature extraction portion 185 extracts a prompt feature vector, which is a feature vector of a combined prompt, which is data formed by combining a base prompt, which is data indicating a class in image classification and an input image class, which is the class of the input image, and a control prompt, which is the data to be updated.

The similarity calculation portion 186 calculates the similarity between the prompt feature vector and the image feature vector.

The control prompt update portion 189 updates the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

The output image acquisition portion 190 acquires an image using the prompt feature vector according to the updated control prompt.

The image acquisition device 100 can reduce the likelihood of outputting an image that is deemed undesirable.

Specifically, the control prompt update portion 189 performs learning of the control prompt (updating the values of the control prompt) using an evaluation function that outputs an evaluation value that indicates a worse evaluation the higher the similarity indicated by the similarity degree in a case where the input image class is a suppression target class, which is a class for which image output should be suppressed, and that outputs an evaluation value that indicates a better evaluation the higher the similarity indicated by the similarity degree in a case where the input image class is a class other than the suppression target class. The learning is conducted to improve the evaluation indicated by the evaluation value, and it is thought that the classification accuracy of images in the suppression target class will decrease.

Furthermore, since the output image acquisition portion 190 acquires the output image using the learned control prompt and a prompt feature vector derived using the same feature extraction method as used in a case where learning the control prompt, it is conceivable that the classification accuracy of images of the suppression target class will be relatively low even in a case where the output image is acquired. Since the classification accuracy of images of the suppression target class is relatively low, it is expected that the possibility that the output image acquisition portion 190 acquires an image of the suppression target class is relatively low.

Furthermore, according to the image acquisition device 100, the acquisition of an image by the output image acquisition portion 190 leverages a learned machine learning model as is, suggesting that relatively simple processing (relatively simple learning) can be expected to reduce the likelihood of outputting undesirable images. In addition, according to the image acquisition device 100, in that the technique of image class classification is used to reduce the possibility of outputting an image of an undesirable class, it is expected that the possibility of outputting an undesirable image can be reduced with relatively simple processing (relatively simple learning) compared to, for example, reducing the possibility of generating an undesirable image in an image generation process.

The output image acquisition portion 190 also generates an image using the prompt feature vector based on the updated control prompt.

The image acquisition device 100 is expected to reduce the possibility of generating an image that is classified as belonging to the suppression target class.

In addition, the output image acquisition portion 190 acquires an image through an image search using an image generated using the prompt feature vector based on the updated control prompt.

According to the image acquisition device 100, the possibility of generating an image classified as belonging to the suppression target class is reduced, and as a result of an image search using the generated image, it is expected that the possibility of acquiring an image classified as belonging to the suppression target class is reduced.

In addition, the output image acquisition portion 190 acquires an image through an image search using the prompt feature vector based on the updated control prompt.

The image acquisition device 100 is expected to reduce the possibility of acquiring an image classified as belonging to the suppression target class through the image search.

The input image is an image obtained by an image search using a keyword indicating the input image class.

By having the image acquisition device 100 search for the input image, the operator who causes the image acquisition device 100 to learn the prompt does not need to input the input image to the image acquisition device 100. In this respect, it is expected that the image acquisition device 100 can reduce the burden on the operator who causes the image acquisition device 100 to perform prompt learning.

### Second Example Embodiment

FIG. 7 illustrates an example configuration of an image acquisition system according to at least one example embodiment. In the configuration shown in FIG. 7, the image capture system 10 includes a prompt learning device 300 and an image acquisition device 400.

The prompt learning device 300 performs prompt learning in a manner similar to that of the image acquisition device 100. The prompt learning device 300 then transmits the learned combined prompt to the image acquisition device 400.

The image acquisition device 400 acquires and outputs an output image using the learned combined prompt received from the prompt learning device 300.

Alternatively, the prompt learning device 300 may transmit the learned control prompt to the image acquisition device 400. Then, the image acquisition device 400 may acquire a base prompt and generate a combined prompt by combining the acquired base prompt with the learned control prompt. The image acquisition device 400 may then acquire an image using the generated combined prompt.

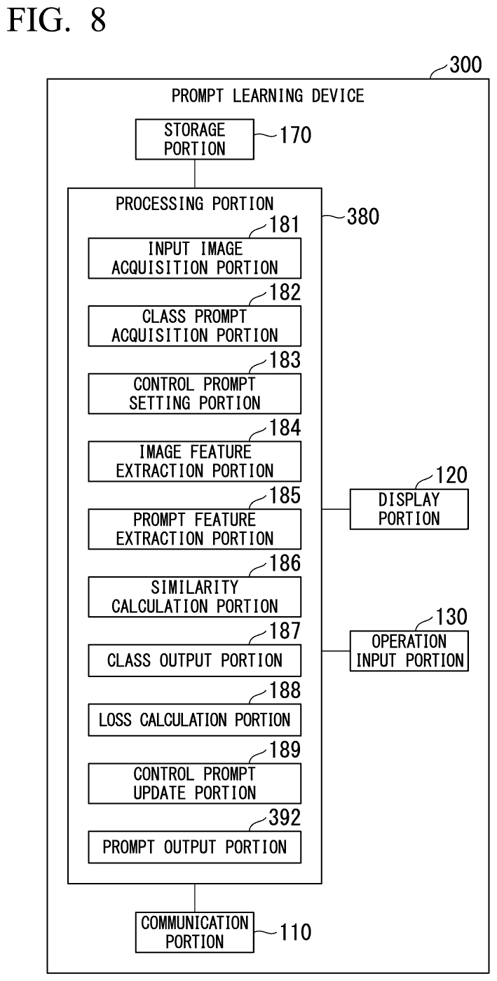

FIG. 8 is a diagram showing an example of the configuration of the prompt learning device 300. In the configuration shown in FIG. 8, the prompt learning device 300 is provided with a communication portion 110, a display portion 120, an operation input portion 130, a storage portion 170, and a processing portion 380.

The processing portion 380 is provided with an input image acquisition portion 181, a base prompt acquisition portion 182, a control prompt setting portion 183, an image feature extraction portion 184, a prompt feature extraction portion 185, a similarity calculation portion 186, a class output portion 187, a loss calculation portion 188, a control prompt update portion 189, and a prompt output portion 392.

Among the components in FIG. 8, those that correspond to the respective parts in FIG. 1 and have the same functions are given the same reference numerals (110, 120, 130, 170, 181, 182, 183, 184, 185, 186, 187, 188, 189), and detailed description thereof will be omitted here.

The prompt learning device 300 differs from the image acquisition device 100 in that the processing portion 380 does not include the output image acquisition portion 190 and the image output portion 191, which are included in the processing portion 180 of the image acquisition device 100, and instead includes the prompt output portion 392. In other respects, the prompt learning device 300 is similar to the image acquisition device 100.

The prompt output portion 392 transmits the learned combined prompt to the image acquisition device 400 via the communication portion 110.

The image acquisition system 10 can be regarded as a system in which the output image acquisition portion 190 and the image output portion 191 of the image acquisition device 100 are configured as a separate device, namely the image acquisition device 400, distinct from the image acquisition device 100.

Similar to the output image capture portion 190a of FIG. 3, the image acquisition device 400 may generate the output image. In this case, the image acquisition device 400 may use an existing foundation model that receives a prompt input and generates an image. The prompt feature extraction portion 185 of the prompt learning device 300 may extract the prompt feature vector using the same process as that performed by the text encoding of the existing foundation model.

As in the case of the output image acquisition portion 190b in FIG. 4, the image acquisition device 400 may generate an image and use the generated image as a search image to search for an output image. In this case, the image acquisition device 400 may be a combination of an existing foundation model that receives a prompt input and generates an image, and an existing image search engine that performs an image-image search. The prompt feature extraction portion 185 of the prompt learning device 300 may extract the prompt feature vector using the same process as that performed by the text encoding of the existing foundation model. The image-image extractor may also perform image search using the images generated by the foundation model as search images.

As in the case of the output image acquisition portion 190c in FIG. 5, the image acquisition device 400 may acquire the output image by image search. In this case, the image acquisition device 400 may use an existing foundation model that receives a prompt input and performs an image search. The prompt feature extraction portion 185 of the prompt learning device 300 may extract the prompt feature vector using the same process as that performed by the text encoding of the existing foundation model.

As described above, the image feature extraction portion 184 extracts an image feature vector, which is a feature vector of an input image that is an image of any one of the classes in image classification.

The prompt feature extraction portion 185 extracts a prompt feature vector, which is a feature vector of a combined prompt, which is data formed by combining a base prompt, which is data indicating a class in image classification and an input image class, which is the class of the input image, and a control prompt, which is the data to be updated.

The similarity calculation portion 186 calculates the similarity between the prompt feature vector and the image feature vector.

The control prompt update portion 189 updates the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

According to the prompt learning device 300, by inputting a learned prompt from the prompt learning device 300 into a device that receives a prompt input and acquires an image, it is expected that in a case where an image is output in response to the input of a prompt, the possibility of an undesirable image being output can be reduced.

The input image is an image obtained by an image search using a keyword indicating the input image class.

By having the prompt learning device 300 search for the input image, the operator who causes the prompt learning device 300 to perform prompt learning does not need to input the input image to the prompt learning device 300. In this respect, the prompt learning device 300 is expected to reduce the burden on the operator who causes the prompt learning device 300 to perform prompt learning.

### Third Example Embodiment

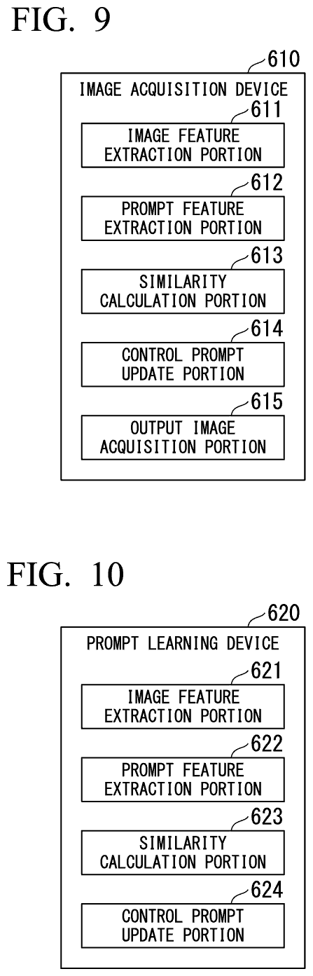

FIG. 9 illustrates an example configuration of an image acquisition device according to at least one example embodiment. In the configuration shown in FIG. 9, an image acquisition device 610 is provided with an image feature extraction portion 611, a prompt feature extraction portion 612, a similarity calculation portion 613, a control prompt update portion 614, and an output image acquisition portion 615.

With this configuration, the image feature extraction portion 611 extracts an image feature vector, which is a feature vector of an input image that is an image of any one of the classes in the image classification.

The prompt feature extraction portion 612 extracts a prompt feature vector, which is a feature vector of a combined prompt, which is data formed by combining a base prompt, which is data indicating the class in the image classification and the input image class, which is the class of the input image, and a control prompt, which is the data to be updated.

The similarity calculation portion 613 calculates the similarity between the prompt feature vector and the image feature vector.

The control prompt update unit 614 updates the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

The output image acquisition portion 615 acquires an image using the prompt feature vector according to the updated control prompt.

The image feature extraction portion 611 corresponds to an example of an image feature extraction means. The prompt feature extraction portion 612 corresponds to an example of a prompt feature extraction means. The similarity calculation portion 613 corresponds to an example of a similarity calculation means. The control prompt update portion 614 corresponds to an example of a control prompt update means. The output image acquisition portion 615 corresponds to an example of an output image acquisition means.

The image acquisition device 610 can reduce the likelihood of outputting an image that is deemed undesirable.

Specifically, the control prompt update portion 614 performs learning of the control prompt (updating the values of the control prompt) using an evaluation function that outputs an evaluation value that indicates a worse evaluation the higher the similarity indicated by the similarity degree in a case where the input image class is a suppression target class, which is a class for which image output should be suppressed, and that outputs an evaluation value that indicates a better evaluation the higher the similarity indicated by the similarity degree in a case where the input image class is a class other than the suppression target class. The learning is conducted to improve the evaluation indicated by the evaluation value, and it is thought that the classification accuracy of images in the suppression target class will decrease.

Furthermore, since the output image acquisition portion 615 acquires the output image using the learned control prompt and a prompt feature vector derived using the same feature extraction method as used in a case where learning the control prompt, it is conceivable that the classification accuracy of images of the suppression target class will be relatively low even in a case where the output image is acquired. Since the classification accuracy of images of the suppression target class is relatively low, it is expected that the possibility that the output image acquisition portion 615 acquires an image of the suppression target class is relatively low.

Furthermore, according to the image acquisition device 610, the acquisition of an image by the output image acquisition portion 615 leverages a learned machine learning model as is, suggesting that relatively simple processing (relatively simple learning) can be expected to reduce the likelihood of outputting undesirable images. In addition, according to the image acquisition device 610, in that the technique of image class classification is used to reduce the possibility of outputting an image of an undesirable class, it is expected that the possibility of outputting an undesirable image can be reduced with relatively simple processing (relatively simple learning) compared to, for example, reducing the possibility of generating an undesirable image in an image generation process.

The image feature extraction portion 611 can be realized by using the functions of the image feature extraction portion 184 in FIG. 1. The prompt feature extraction portion 612 can be realized, for example, by using the function of the prompt feature extraction portion 185 in FIG. 1. The similarity calculation portion 613 can be realized by using the function of the similarity calculation portion 186 in FIG. 1. The control prompt update portion 614 can be realized, for example, by using the function of the control prompt update portion 189 in FIG. 1. The output image acquisition portion 615 can be realized by using the function of the output image acquisition portion 190 in FIG. 1.

### Fourth Example Embodiment

FIG. 10 illustrates an example configuration of a prompt learning device according to at least one example embodiment. In the configuration shown in FIG. 10, the prompt learning device 620 is provided with an image feature extraction portion 621, a prompt feature extraction portion 622, a similarity calculation portion 623, and a control prompt update portion 624.

With this configuration, the image feature extraction portion 621 extracts an image feature vector, which is a feature vector of an input image that is an image of any one of the classes in the image classification.

The prompt feature extraction portion 622 extracts a prompt feature vector, which is a feature vector of a combined prompt, which is data formed by combining a base prompt, which is data indicating a class in image classification and an input image class, which is the class of the input image, and a control prompt, which is the data to be updated.

The similarity calculation portion 623 calculates the similarity between the prompt feature vector and the image feature vector.

The control prompt update portion 624 updates the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

The image feature extraction portion 621 corresponds to an example of an image feature extraction means. The prompt feature extraction portion 622 corresponds to an example of a prompt feature extraction means. The similarity calculation portion 623 corresponds to an example of a similarity calculation means. The control prompt update portion 624 corresponds to an example of a control prompt update means.

According to the prompt learning device 620, by inputting a learned prompt from the prompt learning device 620 into a device that receives a prompt input and acquires an image, it is expected that in a case where an image is output in response to the input of a prompt, the possibility of an undesirable image being output can be reduced.

The image feature extraction portion 621 can be realized by using the functions of the image feature extraction portion 184 in FIG. 1. The prompt feature extraction portion 622 can be realized, for example, by using the function of the prompt feature extraction portion 185 in FIG. 1. The similarity calculation portion 623 can be realized by using the function of the similarity calculation portion 186 in FIG. 1. The control prompt update portion 624 can be realized, for example, by using the function of the control prompt update portion 189 in FIG. 1.

### Fifth Example Embodiment

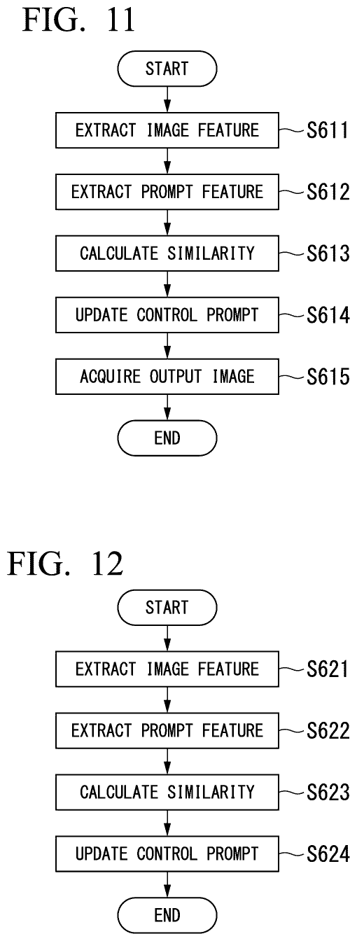

FIG. 11 is a diagram illustrating an example of the processing steps in the image acquisition method of at least one example embodiment. The image acquisition method shown in FIG. 11 includes extracting an image feature (Step S611), extracting a prompt feature (Step S612), calculating the similarity (Step S613), updating the control prompt (Step S614), and acquiring an output image (Step S615).

In extracting an image feature (Step S611), the computer extracts an image feature vector, which is a feature vector of an input image that is an image of one of the classes in the image classification.

In extracting a prompt feature (Step S612), the computer extracts a prompt feature vector, which is a feature vector of a combined prompt, which is data formed by combining a base prompt, which is data indicating a class in image classification and an input image class, which is the class of the input image, and a control prompt, which is the data to be updated.

In calculating the similarity (Step S613), the computer calculates the similarity between the prompt feature vector and the image feature vector.

In updating the control prompt (Step S614), the computer updates the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better. In obtaining an output image (Step S615), the computer acquires an image using the prompt feature vector according to the updated control prompt.

According to the image acquisition method shown in FIG. 11, the possibility of an undesirable image being output can be reduced.

Specifically, learning of the control prompt (updating the values of the control prompt) is performed using an evaluation function that outputs an evaluation value that indicates a worse evaluation the higher the similarity indicated by the similarity degree in a case where the input image class is a suppression target class, which is a class for which image output should be suppressed, and that outputs an evaluation value that indicates a better evaluation the higher the similarity indicated by the similarity degree in a case where the input image class is a class other than the suppression target class. The learning is conducted to improve the evaluation indicated by the evaluation value, and it is thought that the classification accuracy of images in the suppression target class will decrease.

Furthermore, by acquiring the output image using the learned control prompt and a prompt feature vector derived using the same feature extraction method as used in a case where learning the control prompt, it is conceivable that the classification accuracy of images of the suppression target class will be relatively low even in a case where the output image is acquired. Since the classification accuracy of images of the suppression target class is relatively low, it is expected that the possibility of acquiring images of the suppression target class is relatively low.

In addition, according to the image acquisition method shown in FIG. 11, since a learned machine learning model is used as is for image acquisition, it is expected that the possibility of outputting an undesirable image can be reduced with relatively simple processing (relatively simple learning).

In addition, according to the image acquisition method shown in FIG. 11, in that the technique of image class classification is used to reduce the possibility of outputting an image of an undesirable class, it is expected that the possibility of outputting an undesirable image can be reduced with relatively simple processing (relatively simple learning) compared to, for example, reducing the possibility of generating an undesirable image in an image generation process.

### Sixth Example Embodiment

FIG. 12 illustrates an example of the processing steps in the prompt learning method of at least one example embodiment. The prompt learning method shown in FIG. 12 includes extracting an image feature (Step S621), extracting a prompt feature (Step S622), calculating similarity (Step S623), and updating the control prompt (Step S624).

In extracting an image feature (Step S621), the computer extracts an image feature vector, which is a feature vector of an input image that is an image of one of the classes in the image classification.

In extracting a prompt feature (Step S622), the computer extracts a prompt feature vector, which is a feature vector of a combined prompt, which is data formed by combining a base prompt, which is data indicating a class in image classification and an input image class, which is the class of the input image, and a control prompt, which is the data to be updated.

In calculating the similarity (Step S623), the computer calculates the similarity between the prompt feature vector and the image feature vector.

In updating the control prompt (Step S624), the computer updates the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

According to the prompt learning method shown in FIG. 12, by inputting a learned prompt using the prompt learning method shown in FIG. 12 into a device that receives a prompt input and acquires an image, it is expected that in a case where an image is output in response to a prompt input, the possibility of an undesirable image being output can be reduced.

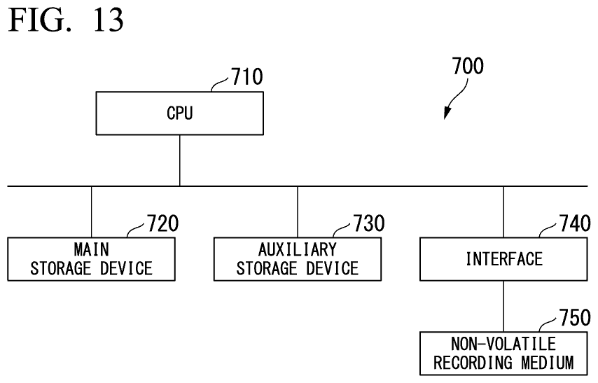

FIG. 13 illustrates an example configuration of a computer in accordance with at least one example embodiment. In the configuration shown in FIG. 13, a computer 700 is provided with a CPU 710, a main storage device 720, an auxiliary storage device 730, an interface 740, and a non-volatile recording medium 750.

Any one or more of the above image acquisition device 100, prompt learning device 300, image acquisition device 400, image acquisition device 610, and prompt learning device 620, or a portion thereof, may be implemented in the computer 700. In this case, the operations of the above-mentioned processing portions are stored in the auxiliary storage device 730 in the form of a program. The CPU 710 reads the program from the auxiliary storage device 730, loads it into the main storage device 720, and executes the above-mentioned processing in accordance with the program. Furthermore, the CPU 710 allocates storage areas in the main storage device 720 corresponding to the above-mentioned respective storage portions in accordance with the program. Communication between each device and other devices is performed by the interface 740 having a communication function and performing communication under the control of the CPU 710. The interface 740 also has a port for the non-volatile recording medium 750, and reads information from the non-volatile recording medium 750 and writes information to the non-volatile recording medium 750.

In a case where the image acquisition device 100 is implemented in the computer 700, the operations of the processing portion 180 and each of its components are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a memory area for the storage portion 170 in the main memory device 720 in accordance with the program. Communication with other devices by the communication portion 110 is performed by the interface 740 having a communication function and operating under the control of the CPU 710. The display of images by the display portion 120 is executed by having the interface 740 equipped with a display device and displaying various images under the control of the CPU 710. The operation input portion 130 receives user operations by having an interface 740 equipped with an input device and receiving the user operations under the control of the CPU 710.

In a case where the prompt learning device 300 is implemented in the computer 700, the operations of the processing portion 380 and each of its components are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a memory area for the storage portion 170 in the main memory device 720 in accordance with the program. Communication with other devices by the communication portion 110 is performed by the interface 740 having a communication function and operating under the control of the CPU 710. The display of images by the display portion 120 is executed by having the interface 740 equipped with a display device and displaying various images under the control of the CPU 710. The operation input portion 130 receives user operations by having an interface 740 equipped with an input device and receiving the user operations under the control of the CPU 710.

In a case where the image acquisition device 400 is implemented in the computer 700, its operations are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the image acquisition device 400 to perform processing in accordance with the program. Communication between the image acquisition device 400 and other devices is performed by the interface 740 having a communication function and operating under the control of the CPU 710. Interaction between the image acquisition device 400 and a user is performed by the interface 740 having an input device and an output device, presenting information to the user via the output device under the control of the CPU 710, and receiving user operations via the input device.

In a case where the image acquisition device 610 is implemented in the computer 700, the operations of the image feature extraction portion 611, the prompt feature extraction portion 612, the similarity calculation portion 613, the control prompt update portion 614, and the output image acquisition portion 615 are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the image acquisition device 610 to perform processing in accordance with the program. Communication between the image acquisition device 610 and other devices is performed by the interface 740 having a communication function and operating under the control of the CPU 710. Interaction between the image acquisition device 610 and a user is performed by the interface 740 having an input device and an output device, presenting information to the user via the output device under the control of the CPU 710, and receiving user operations via the input device.

In a case where the prompt learning device 620 is implemented in the computer 700, the operations of the image feature extraction portion 621, the prompt feature extraction portion 622, the similarity calculation portion 623, and the control prompt update portion 624 are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a memory area in the main memory 720 for the prompt learning device 620 to carry out processing in accordance with the program. Communication between the prompt learning device 620 and other devices is performed by the interface 740 having a communication function and operating under the control of the CPU 710. Interaction between the prompt learning device 620 and the user is carried out by the interface 740 having an input device and an output device, presenting information to the user via the output device under the control of the CPU 710, and accepting user operations via the input device.

Any one or more of the above-mentioned programs may be recorded in the non-volatile recording medium 750. In this case, the interface 740 may read the program from the non-volatile recording medium 750. The CPU 710 may then directly execute the program read by the interface 740, or may temporarily store the program in the main storage device 720 or the auxiliary storage device 730 and then execute it.

In addition, a program for executing all or part of the processing performed by the image acquisition device 100, the prompt learning device 300, the image acquisition device 400, the image acquisition device 610, and the prompt learning device 620 may be recorded on a computer-readable recording medium, and the program recorded on this recording medium may be read into a computer system and executed to perform the processing of each part. It should be noted that the term “computer system” herein includes an OS (Operating System) and hardware such as peripheral devices.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing some of the functions described above, and may further be capable of realizing the functions described above in combination with a program already recorded in the computer system.

According to one example aspect of the present disclosure, in a case where an image is output in response to input of a prompt, the possibility that an undesirable image is output can be reduced.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

Some or all of the above-described example embodiments can be described as follows, but is not limited to the following.

### (Supplementary Note 1)

An image acquisition device comprising:
an image feature extraction means for extracting an image feature vector, which is a feature vector of an input image that is an image of any one of the classes in image classification;
a prompt feature extraction means for extracting a prompt feature vector, which is a feature vector of a combined prompt, which is data formed by combining a base prompt, which is data indicating a class in the image classification and an input image class, which is a class of the input image, and a control prompt, which is data to be updated;
a similarity calculation means for calculating the similarity between the prompt feature vector and the image feature vector;
a control prompt update means for updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better; and
an output image acquisition means for acquiring an image using the prompt feature vector according to the updated control prompt.

### (Supplementary Note 2)

The image acquisition device according to Supplementary Note 1,
wherein the output image acquisition means generates an image using the prompt feature vector according to the updated control prompt.

### (Supplementary Note 3)

The image acquisition device according to Supplementary Note 2,
wherein the output image acquisition means acquires an image through an image search using an image generated using the prompt feature vector according to the updated control prompt.

### (Supplementary Note 4)

The image acquisition device according to any one of supplementary notes 1 to 3,
wherein the output image acquisition means acquires an image through an image search using the prompt feature vector according to the updated control prompt.

### (Supplementary Note 5)

The image acquisition device according to any one of supplementary notes 1 to 4,
wherein the input image is an image obtained by an image search using a keyword indicating the input image class.

### (Supplementary Note 6)

A prompt learning device comprising:
an image feature extraction means for extracting an image feature vector, which is a feature vector of an input image that is an image of any one of the classes in image classification;
a prompt feature extraction means for extracting a prompt feature vector, which is a feature vector of a combined prompt, which is data formed by combining a base prompt, which is data indicating a class in the image classification and an input image class, which is a class of the input image, and a control prompt, which is data to be updated;
a similarity calculation means for calculating the similarity between the prompt feature vector and the image feature vector; and
a control prompt update means for updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

### (Supplementary Note 7)

The prompt learning device according to Supplementary Note 6,
wherein the input image is an image obtained by an image search using a keyword indicating the input image class.

### (Supplementary Note 8)

An image acquisition method includes a computer performing the steps of:
extracting an image feature vector, which is a feature vector of an input image that is an image of any one of classes in image classification;
extracting a prompt feature vector, which is a feature vector of a combined prompt, which is data formed by combining a base prompt, which is data indicating a class in the image classification and an input image class, which is a class of the input image, and a control prompt, which is data to be updated, and calculating a similarity between the prompt feature vector and the image feature vector;
updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better; and
acquiring an image using the prompt feature vector according to the updated control prompt.

### (Supplementary Note 9)

The image acquisition method according to Supplementary Note 8,
wherein acquiring the image includes the computer generating an image using the prompt feature vector according to the updated control prompt.

### (Supplementary Note 10)

The image acquisition method according to Supplementary Note 9,
wherein acquiring the image includes the computer acquiring an image through an image search using an image generated using the prompt feature vector according to the updated control prompt.

### (Supplementary Note 11)

The image acquisition method according to any one of supplementary notes 8 to 10,
wherein acquiring the image includes the computer acquiring an image through an image search using the prompt feature vector according to the updated control prompt.

### (Supplementary Note 12)

The image acquisition method according to any one of supplementary notes 8 to 11,
wherein the input image is an image obtained by an image search using a keyword indicating the input image class.

### (Supplementary Note 13)

A prompt learning method includes a computer performing the steps of:
extracting an image feature vector, which is a feature vector of an input image that is an image of any one of classes in image classification;
extracting a prompt feature vector, which is a feature vector of a combined prompt, which is data formed by combining a base prompt, which is data indicating a class in the image classification and an input image class, which is a class of the input image, and a control prompt, which is data to be updated, and calculating a similarity between the prompt feature vector and the image feature vector; and
updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

### (Supplementary Note 14)

The prompt learning method according to Supplementary Note 13,
wherein the input image is an image obtained by an image search using a keyword indicating the input image class.

### (Supplementary Note 15)

A program that causes a computer to execute the steps of:
extracting an image feature vector, which is a feature vector of an input image that is an image of any one of classes in image classification;
extracting a prompt feature vector, which is a feature vector of a combined prompt, which is data formed by combining a base prompt, which is data indicating a class in the image classification and an input image class, which is a class of the input image, and a control prompt, which is data to be updated;
calculating a similarity between the prompt feature vector and the image feature vector, and updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better; and
acquiring an image using the prompt feature vector according to the updated control prompt.

### (Supplementary Note 16)

The program according to Supplementary Note 15, wherein in the step of acquiring the image, the program causes the computer to generate an image using the prompt feature vector according to the updated control prompt.

### (Supplementary Note 17)

The program according to Supplementary Note 16,
wherein in the step of acquiring the image, the program causes the computer to acquire an image through an image search using an image generated using the prompt feature vector according to the updated control prompt.

### (Supplementary Note 18)

The program according to any one of supplementary notes 15 to 17, wherein in the step of acquiring the image, the program causes the computer to acquire an image through an image search using the prompt feature vector according to the updated control prompt.

### (Supplementary Note 19)

The program according to any one of supplementary notes 15 to 18,
wherein the input image is an image obtained by an image search using a keyword indicating the input image class.

### (Supplementary Note 20)

A program that causes a computer to execute the steps of:
extracting an image feature vector, which is a feature vector of an input image that is an image of any one of classes in image classification;
extracting a prompt feature vector, which is a feature vector of a combined prompt, which is data formed by combining a base prompt, which is data indicating a class in the image classification and an input image class, which is a class of the input image, and a control prompt, which is data to be updated; and
calculating a similarity between the prompt feature vector and the image feature vector, and updating the value of the control prompt using an evaluation function that outputs an evaluation value indicating a worse evaluation the higher the similarity indicated by the similarity degree in a case where the input image class is a suppression target class, which is a class for which image output should be suppressed, and that outputs an evaluation value indicating a better evaluation the higher the similarity indicated by the similarity degree in a case where the input image class is a class other than the suppression target class, so that the evaluation indicated by the evaluation value becomes better.

### (Supplementary Note 21)

The program according to Supplementary Note 20,
wherein the input image is an image obtained by an image search using a keyword indicating the input image class.

What is claimed is:

1. An image acquisition device comprising:
at least one memory configured to store instructions; and
at least one processor configured to execute the instructions to:
extract an image feature vector, wherein the image feature vector is a feature vector of an input image, and the input image belongs to a first class of classes in image classification;
extract a prompt feature vector, wherein the prompt feature vector is a feature vector of a combined prompt, the combined prompt is data formed by combining a base prompt and a control prompt, the base prompt is data indicating a class in the image classification and the first class, and the control prompt is data to be updated;
calculate a similarity between the prompt feature vector and the image feature vector;
update the value of the control prompt using an evaluation function so that an evaluation indicated by an evaluation value becomes better, wherein the evaluation function outputs the evaluation value indicating a worse evaluation the higher the similarity indicated by the similarity degree in a case where the first class is a suppression target class, the evaluation function outputs the evaluation value indicating a better evaluation the higher the similarity indicated by the similarity degree in a case where the first class is a class other than the suppression target class, and the suppression target class is a class for which image output should be suppressed; and
acquire an image using the prompt feature vector according to the updated control prompt.

2. The image acquisition device according to claim 1,
wherein the at least one processor is configured to execute the instructions to generate an image using the prompt feature vector according to the updated control prompt.

3. The image acquisition device according to claim 2,
wherein the at least one processor is configured to execute the instructions to acquire an image through an image search using an image generated using the prompt feature vector according to the updated control prompt.

4. The image acquisition device according to claim 1,
wherein the at least one processor is configured to execute the instructions to acquire an image through an image search using the prompt feature vector according to the updated control prompt.

5. The image acquisition device according to claim 1,
wherein the input image is an image obtained by an image search using a keyword indicating the first class.

6. An image acquisition method executed by a computer comprising:
extracting an image feature vector, wherein the image feature vector is a feature vector of an input image, and the input image belongs to a first class of classes in image classification;
extracting a prompt feature vector, wherein the prompt feature vector is a feature vector of a combined prompt, the combined prompt is data formed by combining a base prompt and a control prompt, the base prompt is data indicating a class in the image classification and the first class, and the control prompt is data to be updated;
calculating a similarity between the prompt feature vector and the image feature vector;
updating the value of the control prompt using an evaluation function so that an evaluation indicated by an evaluation value becomes better, wherein the evaluation function outputs the evaluation value indicating a worse evaluation the higher the similarity indicated by the similarity degree in a case where the first class is a suppression target class, the evaluation function outputs the evaluation value indicating a better evaluation the higher the similarity indicated by the similarity degree in a case where the first class is a class other than the suppression target class, and the suppression target class is a class for which image output should be suppressed; and
acquiring an image using the prompt feature vector according to the updated control prompt.

7. The image acquisition method according to claim 6,
wherein acquiring the image includes generating an image using the prompt feature vector according to the updated control prompt.

8. The image acquisition method according to claim 7,
wherein acquiring the image includes acquiring an image through an image search using an image generated using the prompt feature vector according to the updated control prompt.

9. The image acquisition method according to claim 6,
wherein acquiring the image includes acquiring an image through an image search using the prompt feature vector according to the updated control prompt.

10. The image acquisition method according to claim 6,
wherein the input image is an image obtained by an image search using a keyword indicating the first class.

11. A non-transitory storage medium storing a program that causes a computer to execute:
extracting an image feature vector, wherein the image feature vector is a feature vector of an input image, and the input image belongs to a first class of classes in image classification;
extracting a prompt feature vector, wherein the prompt feature vector is a feature vector of a combined prompt, the combined prompt is data formed by combining a base prompt and a control prompt, the base prompt is data indicating a class in the image classification and the first class, and the control prompt is data to be updated;
calculating a similarity between the prompt feature vector and the image feature vector;
updating the value of the control prompt using an evaluation function so that an evaluation indicated by an evaluation value becomes better, wherein the evaluation function outputs the evaluation value indicating a worse evaluation the higher the similarity indicated by the similarity degree in a case where the first class is a suppression target class, the evaluation function outputs the evaluation value indicating a better evaluation the higher the similarity indicated by the similarity degree in a case where the first class is a class other than the suppression target class, and the suppression target class is a class for which image output should be suppressed; and
acquiring an image using the prompt feature vector according to the updated control prompt.

12. The non-transitory storage medium according to claim 11,
wherein acquiring the image includes generating an image using the prompt feature vector according to the updated control prompt.

13. The non-transitory storage medium according to claim 12,
wherein acquiring the image includes acquiring an image through an image search using an image generated using the prompt feature vector according to the updated control prompt.

14. The non-transitory storage medium according to claim 11,
wherein acquiring the image includes acquiring an image through an image search using the prompt feature vector according to the updated control prompt.

15. The non-transitory storage medium according to claim 11,
wherein the input image is an image obtained by an image search using a keyword indicating the first class.
